(19) United States
(12) Patent Application Publication
(10) Pub. No.: US 2026/0178392 A1
(43) Pub. Date: Jun. 25, 2026

(54) LOOKAHEAD RESOURCE ALLOCATION FOR ACCELERATOR UNITS

(71) Applicants: ATI TECHNOLOGIES ULC, MARKHAM (CA); ADVANCED MICRO DEVICES, INC., Santa Clara, CA (US)

(72) Inventors: Ahmed Mohammed ElShafiey Mohammed ElTantawy, Markham (CA); Trinayan Baruah, Santa Clara, CA (US); Mohammad Ewais, Markham (CA)

(21) Appl. No.: 18/999,867

(22) Filed: Dec. 23, 2024

(51) Int. Cl. G06F 9/50

(52) U.S. Cl. CPC G06F 9/5027; G06F 2209/503

(57) ABSTRACT

An accelerator unit (AU) includes a compute unit configured to execute a first workgroup of a first kernel and a set of compute unit resources allocated to the first workgroup. Concurrently with the compute unit executing the first workgroup, a scheduling circuitry of the AU receives a resource termination hint indicating that the first workgroup is going to end the use of portions of compute unit resources allocated to the first workgroup. In response to this resource termination hint, the scheduling circuitry provisionally allocates these portions of compute unit resources to a second workgroup of a second kernel and begins execution of a portion of the second workgroup. After the first workgroup releases the portions of compute unit resources, the scheduling circuitry fully allocates the portions of compute unit resources to the second workgroup and executes a remainer of the second workgroup.

### BACKGROUND

Certain processing systems include a graphics processing unit (GPU) configured to perform various tasks for the application. To enable the GPU to perform these tasks, a processing system is configured to generate compute kernels that indicate one or more groups of waves, also referred to herein as “workgroups,” to be executed by the GPU. When executing such a compute kernel, the GPU schedules a workgroup for execution by allocating one or more processor cores of the GPU and one or more processing resources of the GPU to the workgroup such as a number of registers, caches, and scratch memory necessary for executing the workgroup. The GPU then uses the allocated processor cores and processing resources to execute the waves indicated by the workgroup and stores data resulting from the execution of the workgroup in the memory of the processing system. After storing the resulting data in the memory, the GPU terminates the workgroup and is free to reallocate the processor cores and processing resources to another workgroup of the kernel.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system including an accelerator unit (AU) configured for lookahead workgroup scheduling, in accordance with some embodiments.

FIG. 2 is a block diagram of an example lookahead scheduling circuitry for an AU, in accordance with some embodiments.

FIG. 3 is a flow diagram of an example operation for scheduling workgroups based on resource release hints, in accordance with some embodiments.

FIG. 4 is a flow diagram of a method for lookahead workgroup scheduling, in accordance with some embodiments.

### DETAILED DESCRIPTION

Systems and techniques disclosed herein include a processing system configured to schedule one or more workgroups for multiple kernels for one or more applications. For example, while executing an application, the processing system is configured to generate one or more compute kernels to be executed by an accelerator unit (AU) of the processing system. Each of these kernels, for example, indicates work items (e.g., instructions) to be executed that are arranged into workgroups with each workgroup including a respective number of waves (e.g., sub-groups of work items). To execute the workgroups indicated in these kernels, the AU has one or more compute units each including wave slots (e.g., portions of the compute unit) configured to execute a respective wave of a workgroup (e.g., execute one or more instructions or operations of a wave of the workgroup). Further, each compute unit includes or is otherwise connected to a respective set of compute unit resources (e.g., vector registers, scalar registers, caches, local data shares, scratch memory) configured to store data used in the performance of the operations for the waves of a workgroup. For example, two or more compute units include or are otherwise connected to a shared set of sources compute unit resources configured to store data used in the performance of the operations for the waves of a workgroup such as matrix multiplication operations. As another example, two or more compute units each include or are otherwise connected to corresponding distinct sets of compute unit resources.

To facilitate the execution of the workgroups of the kernels at the compute units of the AU, the AU includes a command processor configured to schedule the workgroups based on the resource requirements of the workgroups (e.g., number or amount of respective compute unit resources needed to execute the workgroup). For example, each kernel also includes performance requirement data that indicates data, instructions, or both associated with the performance of the kernel. This performance requirement data, as an example, includes data, instructions, or both representing attributes (e.g., pointers to code objects, grid dimensions, resource requirements), barriers (e.g., resource barriers, compute barriers), or both of the workgroups indicated in the kernel. When the AU executes a kernel, the data indicating the workgroups and their corresponding performance requirement data are provided to the command processor as, for example, a packet. Scheduling circuitry (e.g., a shader program interface) included in or otherwise connected to the command processor then schedules each indicated workgroup for execution at one or more compute units based on the performance requirement data associated with the kernel. For example, when scheduling a first workgroup of a kernel for execution, the scheduling circuitry first executes a prologue stage for the first workgroup. During this prologue stage for the first workgroup, the scheduling circuitry determines the resource requirements for the first workgroup based on one or more corresponding attributes of the first workgroup indicated in the performance requirement data of the kernel. That is, the scheduling circuitry first determines the number or amount of one or more respective compute unit resources needed to execute the workgroup based on one or more corresponding attributes of the first workgroup indicated in the performance requirement data. As an example, the scheduling circuitry determines a resource requirement indicating that the first workgroup requires 100% of the vector registers associated with a compute unit. The scheduling circuitry then allocates one or more compute units and one or more corresponding portions of the compute resources to the first workgroup based on the determined resource requirements. For example, the scheduling circuitry allocates a compute unit and 100% of the vector registers associated with the compute unit to the first workgroup based on a determined resource requirement indicating that the first workgroup requires 100% of the vector registers associated with a compute unit.

For the prologue stage of the first workgroup, after the scheduling circuitry allocates the compute unit and corresponding portions of compute unit resources to the first workgroup, the scheduling circuitry copies one or more instructions of the first workgroup; stores at least a portion of the data (e.g., instructions, operands, values) used in the execution of the first workgroup in the allocated compute unit resources (e.g., registers, caches, local data shares); sets one or more register values for the first workgroup; or any combination thereof. After completing this prologue stage of the workgroup, the scheduling circuity executes a computation stage of the first workgroup during which the compute unit executes program code to set one or more initial values for one or more allocated registers, load a portion of the data used in the execution of the first workgroup into the allocated compute unit resources, or both. After the data used in the execution of the workgroup has been stored in the allocated compute unit resources, the compute unit executes the instructions indicated in the workgroup using the stored data to generate one or more results. The compute unit then, after executing the instructions of the workgroup, stores the data resulting from the execution of the workgroup (e.g., results) in the memory of the processing system. Additionally, under certain conditions, the scheduling circuitry is configured to release one or more portions of compute unit resources allocated to a workgroup during the compute stage. As an example, based on a workload no longer needing one or more portions of compute unit resources for execution, the scheduling circuitry releases these portions of compute unit resources such that they are able to be allocated to other workgroups.

After the compute unit stores the results of the first workgroup in the memory (e.g., after the first workgroup stores data in the memory), the scheduling circuitry executes an epilogue stage of the first workgroup which includes the scheduling circuitry terminating the execution of the first workgroup and releasing the compute units and one or more portions of the compute unit resources allocated to the first workgroup. After the scheduling circuitry releases the compute units and portions of the compute unit resources allocated to the first workgroup, the scheduling circuitry is enabled to then schedule a second workgroup (e.g., a workgroup of another kernel) for execution using the compute units and portions of the compute unit resources previously allocated to the first workgroup. However, by scheduling the workgroups in this way, the compute units and portions of the compute unit resources previously allocated to the first workgroup of a first kernel are only available after the first workgroup releases the compute units and portions of the compute unit resources. As such, the AU cannot begin executing a second workgroup or second kernel using one or more portions of the compute unit resources until the first workgroup has released the portions of compute unit resources. This delay in executing the second workgroup or second kernel increases the total time needed to execute multiple kernels for an application and negatively impacts processing efficiency.

To help reduce the delay in executing a second workgroup or second kernel, systems and techniques disclosed herein are directed toward an AU configured to implement lookahead scheduling for one or more workgroups. For example, within the processing system, one or more workgroups in a kernel include or are otherwise associated with data indicating one or more resource release hints, resource barriers, dependency barriers, or any combination thereof. A resource release hint, for example, includes an instruction or data (e.g., message, packet, flag) indicating the use of a certain number or amount of one or more compute unit resources allocated to a workgroup is imminently ending. Additionally, a resource barrier indicates a point (e.g., instruction) in a workgroup after which a different (e.g., greater) number or amount of compute unit resources are needed for execution. For example, a resource barrier indicates a certain number of compute unit resources are required after the resource barrier. Such a resource barrier includes data (e.g., message, packet, flag) or an instruction in a wave of the kernel. As an example, a resource barrier includes an instruction that, when executed, generates data indicating a certain number or amount of compute unit resources are needed for further execution. Further, a dependency barrier includes data or an instruction indicating a point in a workgroup after which the workgroup requires data generated by workgroups of one or more other kernels. Also, to implement lookahead scheduling for one or more workgroups of the kernels, the scheduling circuitry of the AU is configured to maintain resource availability data for one or more portions of the compute unit resources of the AU with such resource availability data indicating a corresponding allocation status (e.g., available for allocation, allocated to a workgroup, available for ahead of time allocation, ahead of time allocated to a workgroup) for one or more portions of each compute unit resource of the AU.

While executing a first workgroup (e.g., a first workgroup of a first kernel), the scheduling circuitry of the command processor is configured to receive one or more resource release hints associated with the first workgroup indicating that the use of a certain number or amount of one or more compute unit resources allocated to the workgroup is imminently ending. The scheduling circuitry then updates the resource availability data associated with the portions of compute unit resources indicated in the resource release hint to identify these portions of the compute unit resources as available for lookahead allocation. That is, the scheduling circuitry updates the resource availability data to indicate that these portions of compute unit resources are available for provisional allocation to other workgroups before a current workgroup has released the portions of the compute unit resources. By identifying these resources as available for provisional allocation to other workgroups, the scheduling circuity is enabled to provisionally allocate the resources to a second workgroup (e.g., second workgroup of the first kernel or a second kernel) requesting or requiring a number or amount of compute unit resources equal to or less than the number of compute unit resources identified as available for allocation (e.g., full allocation) and the compute unit resources identified as available for ahead of lookahead allocation. That is, the scheduling circuitry is enabled to execute one or more stages (e.g., prologue stage, compute stage) of a second workgroup requesting or requiring a number or amount of compute unit resources equal to or less than the portions of compute unit resources identified as available for allocation and the portions of compute unit resources identified as available for lookahead allocation such that the scheduling circuitry executes these one or more stages for the second workgroup before the portions of compute unit resources labeled identified as available for lookahead allocation have been released by the first workgroup. As an example, based on resources identified as available for lookahead allocation being provisionally allocated to the second workgroup, the scheduling circuitry begins to execute a prologue stage, compute stage (e.g., up to a resource barrier), or both for the second workgroup before the portions of compute unit resources labeled provisionally allocated to the second workgroup have been released by the first workgroup.

While the scheduling circuitry is executing the prologue stage, a compute stage, or both of the second workgroup based on the portions of compute unit resources being provisionally allocated to the second workgroup, the first workgroup releases these portions of compute unit resources. The scheduling circuitry then fully allocates the portions of compute unit resources to the second workgroup (e.g., allocates the portions of compute unit resources such that they are available for use by the second workgroup). After these resources are fully allocated to the second workgroup, the scheduling circuitry is enabled to continue the prologue stage or compute stage of the second workgroup (e.g., such as after a resource barrier), begin a compute stage of the second workgroup, or both before the first workgroup has terminated.

In this way, the AU is configured to begin executing a second workgroup that will use portions of compute unit resources before those portions of compute unit resources are released by a first workgroup. As such, the AU is enabled to sooner execute workgroups due to the scheduling circuitry not needing to wait until a first workgroup has released certain compute unit resources before beginning execution of a second workgroup that will later use these same compute unit resources. Because the AU is enabled to sooner execute these workgroups for different kernels, the total time needed to execute multiple kernels is reduced, helping to reduce processing times and improve the processing efficiency of the processing system.

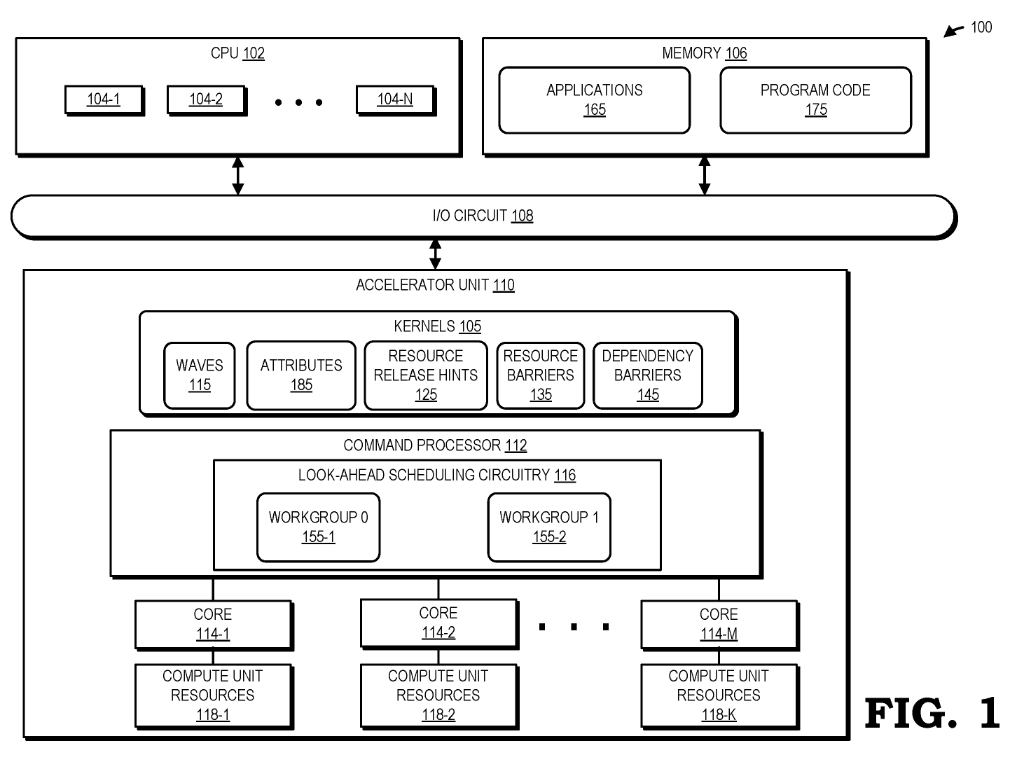

FIG. 1 illustrates a processing system 100 including an AU configured for lookahead workgroup scheduling, in accordance with embodiments. The processing system 100 includes or has access to a memory 106 or other storage component implemented using a non-transitory computer-readable medium, for example, a dynamic random-access memory (DRAM). However, in embodiments, the memory 106 is implemented using other types of memory including, for example, static random-access memory (SRAM), nonvolatile RAM, and the like. According to embodiments, the memory 106 includes an external memory implemented external to the processing units implemented in the processing system 100. In embodiments, processing system 100 is configured to execute one or more applications 165 based on program code 175 stored in memory 106. Such applications 165, for example, include graphics-rendering applications (e.g., gaming applications, virtual reality applications, graphics interfaces), compute applications (e.g., databasing applications, physics applications, simulation applications, design applications), or both. When the processing system 100 executes an application 165, CPU 102 of the processing system 100 is configured to generate one or more compute kernels 105 to be executed at the AU 110. Such a CPU 102, for example, implements a plurality of processor cores 104 that execute instructions concurrently or in parallel. Though the example embodiment presented in FIG. 1 presents CPU 102 as including three processor cores (104-1, 104-2, 104-N) representing an N integer number of processor cores 104, in other embodiments CPU 102 can include any non-zero integer number of processor cores 104. In some embodiments, to enable communication between CPU 102 and one or more other components (e.g., AU 110, memory 106) of processing system 100, processing system 100 includes input/output (I/O) circuit 108. I/O circuit 108 includes, for example, one or more busses, memory controllers, switches (e.g., PCI switches), data fabrics, queues, buffers, or the like. As an example, I/O circuit 108 is configured to connect a command processor 112 of AU 110 to one or more processor cores 104 of CPU 102, memory 106, or both.

AU 110 is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. To execute one or more compute kernels 105, AU 110 implements one or more processor cores 114 that execute instructions (e.g., waves 115) indicated in the kernel 105 concurrently or in parallel. In some implementations, one or more of the processor cores 114 each operate as one or more compute units each configured to execute one or more corresponding waves 115 or workgroups 155 indicated in a kernel 105. For example, each compute unit includes one or more SIMD units that have one or more registers, buffers, arithmetic logic units (ALUs), or any combination thereof configured to execute the operations indicated in a wave 115 or workgroup 155. Further, to enable these compute units to execute these operations, each compute unit has access to a set of compute unit resources 118 that includes one or more vector registers, scalar registers, local data shares (LDSs), caches (e.g., instruction caches, data caches), and the like. According to some embodiments, two or more compute units implemented by a processor core 114 share the same set of compute unit resources 118. Though the example embodiment presented in FIG. 1 shows AU 110 as including three processor cores (114-1, 114-2, 114-M) representing an M integer number of processor cores 114, in other embodiments, AU 110 can include any non-zero integer number of processor cores 114. Additionally, though the example embodiment presented in FIG. 1 shows AU 110 as including one set of compute unit resources 118 for each processor core (e.g., 118-1, 118-2, 118-K) that together represent a K integer number of set of compute unit resources 118, in other embodiments, AU 110 can include any non-zero number of sets of compute unit resources 118.

In embodiments, each compute kernel 105 to be executed by AU 110 includes, for example, data indicating one or more waves 115, attributes 185, resource release hints 125, resource barriers 135, dependency barriers 145, or any combination thereof. Such waves 115, for example, include groups of instructions to be executed by AU 110. Within a kernel 105, the waves 115 are grouped into workgroups 155 such that the compute kernel 105 indicates one or more workgroups 155 to be executed with each indicating one or more waves 115, attributes 185, resource release hints 125, resource barriers 135, dependency barriers 145, or any combination thereof. Further, attributes 185 include data representing pointers to code objects, grid dimensions, or other data indicating the number of compute unit resources 118 needed to execute a workgroup 155. That is to say, attributes 185 include data indicating the number or amount of certain compute unit resources 118 needed to execute a corresponding workgroup 155. In some embodiments, a resource barrier 135 includes data indicating a point (e.g., instruction) in a corresponding workgroup 155 after which a different (e.g., greater) number or amount of certain compute unit resources 118 are needed to execute the workgroup 155. Additionally, in other embodiments, a resource barrier 135 includes an instruction in a wave 115 that, when executed, generates data indicating that a different (e.g., greater) number or amount of certain compute unit resources 118 are needed to continue execution of the workgroup 155. Further, a dependency barrier 145 includes, according to some embodiments, data indicating a point in a corresponding workgroup 155 after which one or more results are needed from the workgroup 155 of another kernel 105. In other embodiments, a dependency barrier 145 includes an instruction of a wave 115 that, when executed, generates data indicating that one or more results are needed from the workgroup 155 of another kernel 105.

When executing a kernel 105, AU 110 first generates a packet indicating the workgroup 155, attributes 185, resource release hints 125, resource barriers 135, and dependency barriers 145 indicated in the kernel 105 and provides this packet to a command processor 112. The command processor 112 includes circuitry, such as one or more microprocessors, queues, buffers, logic units, or the like, configured to schedule the workgroups 155 of one or more kernels 105 for execution by one or more compute units. For example, the command processor 112 includes lookahead scheduling circuitry 116 (e.g., shader program interface) including one or more microprocessors, queues, buffers, logic units, or the like configured to schedule workgroups 155 based on received resource release hints 125. As an example, to schedule a first workgroup 155-1 (e.g., workload 0) of a first kernel 105, lookahead scheduling circuitry 116 first executes a prologue stage for the first workgroup 155-1 during which the lookahead scheduling circuitry 116 determines the number or amount of certain compute unit resources 118 needed to execute the waves 115 of the first workgroup 155. That is, lookahead scheduling circuitry 116 determines the number or amount of vector registers, scalar registers, LDSs, caches, or any combination thereof needed to execute the waves 115 of the first workgroup 155-1. Lookahead scheduling circuitry 116 then allocates one or more compute units and the determined number or amount of certain compute unit resources 118 associated with these compute units to the first workgroup 155-1 (e.g., allocated one or more portions of compute unit resources 118 to the first workgroup 155-1). After the portions of compute unit resources 118 are allocated to the first workgroup 155-1, lookahead scheduling circuitry 116 continues execution of a prologue stage of the first workgroup 155-1 during which lookahead scheduling circuitry 116 determines memory addresses for the first workgroup based on the allocated portions of compute unit resources 118, copies instructions (e.g., waves 115) of the workgroup based on the determined memory addresses, stores the copied instructions and at least a portion of the data (e.g., operands, values) used in the execution of the first workgroup 155-1 in one or more of the allocated portions of compute unit resources 118 (e.g., LDS, instruction cache, data cache), sets one or more register values for the first workgroup 155-1, or any combination thereof.

After completion of this prologue stage, lookahead scheduling circuitry 116 executes a compute stage of the first workgroup 155-1 during which the compute unit executes program code 175 to set one or more initial values for one or more allocated registers, loads a portion of the data used in the execution of the first workgroup 155 into the allocated portions of compute unit resources 118, or both. The compute units allocated to the first workgroup 155-1 then execute one or more operations for the waves 115 of the first workgroup 155-1 using the data stored in the allocated portions of compute unit resources 118. Further, during the compute stage, after the compute units have executed the waves 115 of the first workgroup 155-1, the compute units store the data resulting from the execution of the waves 115 (e.g., results of the compute stage) in memory 106. In some embodiments, during the compute stage, lookahead scheduling circuitry 116 is configured to release one or more portions of compute unit resources 118 allocated to the first workgroup 155-1. For example, in response to the first workgroup 155-1 no longer needing one or more portions of compute unit resources 118 for execution, lookahead scheduling circuitry 116 releases these portions of compute unit resources 118. After the data has been stored in memory 106, lookahead scheduling circuitry 116 executes an epilogue stage for the first workgroup 155-1 during which lookahead scheduling circuitry 116 terminates execution of the first workgroup 155-1, releases one or more portions of the compute unit resources 118 allocated to the first workgroup 155, or both.

In embodiments, lookahead scheduling circuitry 116 is configured to execute at least a portion of a second workgroup 155-2 (e.g., of the first kernel or a second kernel) before the first workgroup 155-1 has released one or more portions of compute unit resources 118 that are to be allocated to the second workgroup 155-2. For example, lookahead scheduling circuitry 116 is configured to maintain resource availability data for one or more portions of each compute unit resource 118 of AU 110 that indicates whether one or more portions of one or more compute unit resources 118 are available for allocation, allocated to a workgroup, available for lookahead allocation, or lookahead allocated. In response to lookahead scheduling circuitry 116 allocating one or more portions of compute unit resources 118 to a workgroup 155, lookahead scheduling circuitry 116 updates the resource availability associated with these portions of compute unit resources 118 to indicate allocated. Additionally, in response to lookahead scheduling circuitry 116 releasing these portions of compute unit resources 118 allocated to the workgroup 155, lookahead scheduling circuitry 116 updates the resource availability associated with these portions of compute unit resources 118 to indicate available for allocation. Using the resource availability data for the compute unit resources 118, lookahead scheduling circuitry 116 is configured to schedule a second workgroup 155-2 such that at least a portion of the second workgroup 155-2 is executed before a first workgroup 155-1 releases one or more portions of compute unit resources 118 that are to be allocated to the second workgroup 155-2.

As an example, according to embodiments, while executing a first workgroup 155-1 (e.g., a compute stage of a first workgroup 155-1), lookahead scheduling circuitry 116 is configured to receive a resource release hint 125 indicating that the first workgroup 155-1 is imminently ending the use of one or more portions of compute unit resources 118 allocated to the first workgroup 155. This resource release hint 125, for example, is indicated by one or more attributes 185 of a kernel 105, generated by an instruction of a wave 115, or both. For example, lookahead scheduling circuitry 116 receives a resource release hint 125 generated by a compute unit indicating that the use of one or more portions of compute unit resources 118 allocated to the first workgroup 155-1 is ending in a predetermined period of time (e.g., a predetermined number of cycles). In response to this resource release hint 125, lookahead scheduling circuitry 116 updates the resource availability data for these portions of compute unit resources 118 to indicate available for lookahead allocation. That is, lookahead scheduling circuitry 116 updates the resource availability data to indicate that these portion of compute unit resources 118 are available for lookahead allocation. Due to these portions of compute unit resources 118 being indicated as available for lookahead allocation, lookahead scheduling circuitry 116 begins execution of at least a portion of a prologue stage, compute stage, or both of the second workgroup 155-2 before these portions of compute unit resources 118 are released from the first workgroup 155-1. For example, lookahead scheduling circuitry 116 first determines that the second workgroup 155-2 requires a certain number or amount of one or more compute unit resources 118 based on the attributes 185, resource barriers 135, dependency barriers 145, or any combination thereof of the second workgroup 155. As an example, lookahead scheduling circuitry 116 determines a certain number or amount of one or more compute unit resources 118 required to execute the compute stage of the second workgroup 155-2. As another example, lookahead scheduling circuitry 116 determines a certain number or amount of one or more compute unit resources 118 required to execute the second workgroup 155-2 in response to a resource barrier 135 being reached. After determining the portions of compute unit resources 118 needed to execute at least a portion of the second workgroup 155-2, lookahead scheduling circuitry 116 allocates one or more compute units to the second workgroup 155 and provisionally allocates the portions of compute unit resources 118 indicated as available for lookahead allocation to the second workgroup 155-2. That is, concurrently with the first workgroup 155-1 using the portions of compute unit resources 118 indicated as available for lookahead allocation, lookahead scheduling circuitry 116 provisionally allocates these portions of compute unit resources 118 to the second workgroup 155-2.

In embodiments, lookahead scheduling circuitry 116 first updates the resource availability data of these provisionally allocated portions of compute unit resources 118 to indicate that the portions of compute unit resources 118 are lookahead or provisionally allocated. Lookahead scheduling circuitry 116 then begins execution of at least a portion of a prologue stage, compute stage, or both of the second workgroup 155-2 based on the portions of compute unit resources 118 provisionally allocated to the second workgroup 155-2 (e.g., based on the portions of compute unit resources 118 being provisionally allocated to the second workgroup 155-2). As an example, lookahead scheduling circuitry 116 executes at least a portion of a prologue stage for the second workgroup 155-2 during which lookahead scheduling circuitry 116 determines memory addresses of the second workgroup 155 based on the provisionally allocated portions of compute unit resources 118, copies instructions based on the determined memory addresses, stores at least a portion of the data used to execute the second workgroup 155-2 in one or more allocated portions of compute units resources 118, sets one or more initial register values, or any combination thereof. As another example, after provisionally allocating one or more portions of compute unit resources 118 to a second workgroup 155-2, lookahead scheduling circuitry 116 execute a compute stage of a second workgroup 155-2 during which a compute unit executes an instruction (e.g., resource barrier 135) indicating a greater number of portions of compute unit resources 118 are needed to continue execution. Lookahead scheduling circuitry 116 then suspends execution of the second workgroup 155-2 until the provisionally allocated portions of compute unit resources 118 are released by the first workgroup 155-1.

For example, concurrently with lookahead scheduling circuitry 116 executing at least a portion of the prologue stage, compute stage, or both of the second workgroup 155, the first workgroup 155-1 ends the use of the portions of compute unit resources 118 provisionally allocated to the second workgroup 155-2. In response to the first workgroup 155-1 ending use of these portions of compute unit resources 118 (e.g., based on the workgroup ending use of the portions of compute unit resources 118), lookahead scheduling circuitry 116 fully allocates (e.g., allocates for use) these portions of compute unit resources 118 to the second workgroup 155 and updates the resource availability data of these portions of compute unit resources 118 to indicate that the portions of compute unit resources 118 are allocated. Lookahead scheduling circuitry 116 then continues execution of the second workgroup 155-2 using the fully allocated portions of compute unit resources 118. For example, using the fully allocated portions of compute unit resources 118, lookahead scheduling circuitry 116 executes at least a portion of the prologue stage, the compute stage, or both of the second workgroup 155-2. As another example, lookahead scheduling circuitry 116 executes at least a portion of a compute stage of the second workgroup 155 after a resource barrier 135 that has been reached. Though the example embodiment presented in FIG. 1 shows lookahead scheduling circuitry 116 as scheduling two workgroups (155-1, 155-2), in other embodiments, lookahead scheduling circuitry 116 is configured to schedule any non-zero integer number of workgroups 155 for one or more kernels 105.

In this way, lookahead scheduling circuitry 116 is enabled to begin execution of a second workgroup 155-2 before a first workgroup 155-1 stops using portions of compute unit resources 118 that are to be allocated to the second workgroup 155. That is, due to lookahead scheduling circuitry 116 receiving a resource release hint 125, lookahead scheduling circuitry 116 determines that the use of certain portions of compute unit resources 118 is about to end. Lookahead scheduling circuitry 116 is then enabled to begin execution of at least a portion of a prologue stage, compute stage, or both of a second workgroup 155-2 that does not require the portions compute unit resources 118 that are to be released. After these portions compute unit resources 118 are released by the first workgroup 155-1, lookahead scheduling circuitry 116 is then configured to complete the prologue stage, compute stage, or both of the second workgroup 155-2 using the released portions of compute unit resources 118. Because lookahead scheduling circuitry 116 is enabled to execute at least a portion of the second workgroup 155-2 even before the portions of compute unit resources 118 to be allocated to the second workgroup 155-2 are released from a first workgroup 155-1, lookahead scheduling circuitry 116 is configured to more quickly execute the second workgroup 155-2 which reduces processing times and improves processor efficiency. Additionally, because lookahead scheduling circuitry 116 is enabled to execute at least a portion of the second workgroup 155-2 even before the portions of compute unit resources 118 to be allocated to the second workgroup 155-2 are released from a first workgroup 155, the processing system 100 is enabled to delay (e.g., place later) the point (e.g., instruction) of a resource barrier 135 or dependency barrier 145 in the second workgroup 155-2. As such, a greater portion of the second workgroup 155-2 is able to be executed by AU 110 before a respective resource barrier 135 or dependency barrier 145 is reached, which reduces the total time needed to execute the kernel 105.

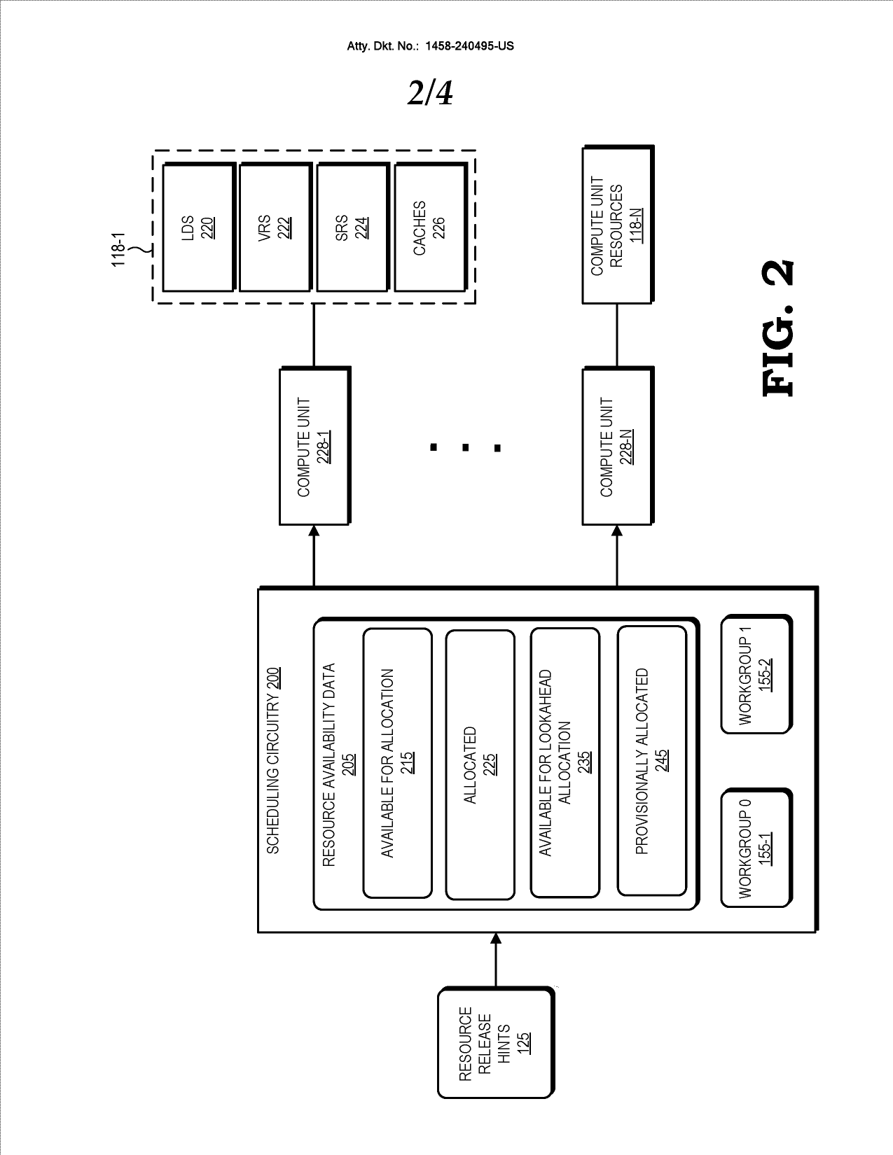

Referring now to FIG. 2, is an example scheduling circuitry 200 configured for lookahead scheduling of workgroups, in accordance with some embodiments. In embodiments, example scheduling circuitry 200 is implemented in processing system 100 as lookahead scheduling circuitry 116 of AU 110. According to embodiments, example scheduling circuitry 200 is configured to schedule one or more workgroups 155 of a kernel 105 to corresponding compute units (228-1, 228-N) for execution. A compute unit 228, for example, is configured to execute one or more corresponding waves 115 or workgroups 155 indicated in a kernel 105. For example, a compute unit 228 includes one or more SIMD units that have one or more registers, buffers, arithmetic logic units (ALUs), or any combination thereof configured to execute the operations indicated in a wave 115 or workgroup 155. Further, in some embodiments, the SIMD units of a compute unit 228 are arranged into one or more waveslots configured to execute corresponding waves 115 of a workgroup 155. An example, two or more waveslots of a compute unit 228 are configured to concurrently execute corresponding waves 115 of a workgroup 155. According to some embodiments, one or more processor cores 114 of AU 110 are each configured to implement one or more compute units 228. Further, to enable these compute units 228 to execute a workgroup 155, each compute unit 228 includes or is otherwise connected to a corresponding set of compute unit resources 118 that include one or more LDSs 220, vector registers 222, scalar registers 224, caches 226 (e.g., instruction caches, data caches), or any combination thereof. Though the example embodiment presented in FIG. 2 shows example scheduling circuitry 200 as scheduling workgroups 155 on two compute units (228-1, 228-N) representing an N integer number of compute units of AU 110, in other embodiments, example scheduling circuitry 200 can scheduling workgroups 155 on any non-zero integer number of compute units of AU 110.

To schedule a workgroup 155 for execution at a compute unit 228, example scheduling circuitry 200 begins execution of a prologue stage of the workgroup 155 during which example scheduling circuitry 200 is configured to first determine the number or amount of certain compute unit resources 118 needed to execute the workgroup 155. For example, example scheduling circuitry 200 is configured to determine the number or amount of certain compute unit resources 118 needed to execute the workgroup 155 (e.g., resource requirements) based on attributes 185, resources barriers 135, dependency barriers 145, or any combination thereof of the workgroup 155 as indicated, for example, by the kernel 105 being executed. After determining the number or amount of certain compute unit resources 118 needed to execute the workgroup 155, example scheduling circuitry 200 allocates one or more compute units 228 having the number or amount of certain compute unit resources 118 needed to execute the workgroup 155 to the workgroup 155. Additionally, example scheduling circuitry 200 allocates the number or amount of certain compute unit resources 118 from the sets of compute unit resources 118 associated with these allocated compute units 228 to the workgroup 155. In response to allocating one or more compute unit resources 118 to a workgroup 155, example scheduling circuitry 200 is configured to update resource availability data 205. For example, example scheduling circuitry 200 is configured to maintain resource availability data 205 for the compute unit resources 118 of AU 110 with such resource availability data 205 indicating the allocation status of the compute unit resources 118. Such an allocation status, for example, indicates whether one or more portions of the compute unit resources 118 of AU 110 are available for allocation 215 (e.g., available to be allocated to a workgroup 155), allocated 225 (e.g., currently allocated to a workgroup 155), available for lookahead allocation 235 (e.g., available to be provisionally allocated to a workgroup 155 before the portions of the compute unit resource 118 are released from a previous workgroup 155), or provisionally allocated 245 (e.g., indicated as allocated to a workgroup 155 before the portions of the compute unit resource 118 are released from a previous workgroup 155). According to embodiments, before any workgroups 155 are scheduled for execution at the compute units 228, example scheduling circuitry 200 maintains the resource availability data 205 such that the resource availability data 205 indicates that one or more portions of the compute unit resources 118 associated with the compute units 228 are available for allocation 215. Further, in response to allocating one or more portions of compute unit resources 118 to a workgroup 155, example scheduling circuitry 200 updates resource availability data 205 to indicate that those one or more portions of the compute unit resources 118 are allocated 225. According to embodiments, resource availability data 205 is stored in example scheduling circuitry 200, AU 110, memory 106, or any combination thereof.

After allocating one or more portions of compute unit resources 118 to a workgroup 155, example scheduling circuitry 200 determines one or more memory addresses for the workgroup 155, copies one or more instructions of the workgroup 155 based on the determined memory addresses, stores at least a portion of the data (e.g., instructions, operands, values) needed to execute the workgroup 155 in the allocated portions of compute unit resources 118 (e.g., allocated vector registers 222), sets one or more initial register values, or any combination thereof. Example scheduling circuitry 200 then executes a compute stage of the workgroup 155 which includes example scheduling circuitry 200 storing a portion of the data needed to execute the workgroup 155 in the allocated portions of compute unit resources 118, example scheduling circuitry 200 setting one or more initial register values, the compute units 228 allocated to the workgroup 155 executing the waves 115 of the workgroup 155 using the data stored in the allocated portions of the compute unit resources 118, or any combination thereof. Under certain conditions, during the compute stage, example scheduling circuitry 200 is configured to release one or more portions of compute unit resources 118 allocated to the workgroup 155. For example, after the workgroup no longer needs one or more portions of compute unit resources 118 for execution, example scheduling circuitry 200 releases these portions of compute unit resources 118. Further, after the compute units 228 have executed the waves 115 of the workgroup 155, the compute units 228 store data resulting from the execution of these waves 115 (e.g., results) in memory 106. Example scheduling circuitry 200 then executes an epilogue stage of the workgroup 155 during which example scheduling circuitry 200 terminates the workgroup 155, releases one or more portions of the compute unit resources 118 allocated to the workgroup 155, or both. As an example, example scheduling circuitry 200 releases one or more portions of the compute unit resources 118 allocated to the workgroup 155 and updates the resource available data 205 to indicate that these released portions of the compute unit resources 118 are available for allocation 215.

In embodiments, example scheduling circuitry 200 is configured to begin execution of a second workgroup 155-2, represented in FIG. 2 as workgroup 1, before a first workgroup 155-1, represented in FIG. 2 as workgroup 0, has stopped using one or more portions of compute unit resources 118 that are to be allocated to the second workgroup 155-2. For example, while one or more compute units 228 are executing the first workgroup 155-1 (e.g., executing a compute stage of the workgroup 155), example scheduling circuitry 200 is configured to receive a resource release hint 125. As an example, one or more compute units 228 execute an instruction of the first workgroup 155 that provides a resource release hint 125 to example scheduling circuitry 200 or executes an instruction of the first workgroup 155 having a flag indicating a resource release hint 125. Such a resource release hint 125 indicates, for example, that the first workgroup 155-1 is imminently going to end the use of a certain number or amount of compute unit resources 118 allocated to the first workgroup 155-1. That is to say, the resource release hint 125 identifies that the first workgroup 155-1 will end the use of a certain number or amount of compute unit resources 118 allocated to the first workgroup 155-1 in a predetermined amount of time (e.g., a predetermined number of cycles). In response to receiving the resource release hint 125, example scheduling circuitry 200 updates the resource availability data 205 to indicate that the portions of compute unit resources 118 identified in the resource release hint 125 are available for lookahead allocation 235. Example scheduling circuitry 200 then identifies a workgroup 155 requesting use (e.g., requiring the use) of a certain number or amount of compute unit resources 118 equal to or less than the portions of compute unit resources 118 indicated available for lookahead allocation and available for allocation in the resource availability data 205. As an example, example scheduling circuitry 200 first determines the number or amount of compute unit resources 118 required or requested by the second workgroup 155-2 based on one or more attributes 185, a resource barrier 135, a dependency barrier 145, or any combination thereof.

In embodiments, based on the number or amount of compute unit resources 118 required or requested by the second workgroup 155-2, example scheduling circuitry 200 provisionally allocates one or more portions of compute unit resources 118 indicated as available for lookahead allocation 235 to the second workgroup 155-2. Further, example scheduling circuitry 200 updates the resource availability data 205 to indicate that the portions of compute unit resources 118 allocated to the second workgroup 155-2 are provisionally allocated 245. Because these portions of compute unit resources 118 are provisionally allocated to the second workgroup 155-2, example scheduling circuitry 200 then executes at least a portion of a prologue stage, compute stage, or both for the second workgroup 155-2 based on the portions of compute unit resources 118 provisionally allocated to the second workgroup 155-2. As an example, example scheduling circuitry 200 performs one or more operations of a prologue stage or compute stage that do not require the use of the provisionally allocated portions of the compute unit resources 118 such as determining memory addresses based on the portions of compute unit resources 118 provisionally allocated to the second workgroup 155-2, copying instructions based on the determined memory addresses, storing data used in the execution of the second workgroup 155-2 in one or more allocated (e.g., fully allocated) portions of compute unit resources 118, setting initial register values, or any combination thereof. Concurrently with the example scheduling circuitry 200 executing at least a portion of a prologue stage, compute stage, or both of the second workgroup 155-2 based on the portions of compute unit resources 118 provisionally allocated to the second workgroup 155-2, the first workgroup 155-1 ends use of the portions of compute unit resources 118 provisionally allocated to the second workgroup 155-2 and releases these portions of compute unit resources 118. Due to the first workgroup 155-1 no longer using the portions of compute unit resources 118 provisionally allocated to the second workgroup 155-2, example scheduling circuitry 200 fully allocates these portions of compute unit resources 118 to the second workgroup 155-2 such that the portions of compute unit resources 118 are available to be used by the second workgroup 155-2 to continue execution of the prologue stage, compute stage, or both. Additionally, example scheduling circuitry 200 then updates the resource availability data 205 to indicate that the portions of compute unit resources 118 released from the first workgroup 155-1 are now allocated 225 (e.g., allocated to the second workgroup 155.)

Using the portions of compute unit resources 118 now fully allocated to the second workgroup 155-2, example scheduling circuitry 200 performs at least a portion of the prologue stage of the second workgroup 155-2, a compute stage of the second workgroup 155-2, or both. As an example, example scheduling circuitry 200 executes the remainder of a prologue stage of the second workgroup 155-2 during which example scheduling circuitry 200 stores data (e.g., instructions, operands, values) used to execute the second workgroup 155-2 in one or more portions of the compute unit resources 118 allocated to the second workgroup 155-2. As another example, example scheduling circuitry 200 executes a compute stage of the second workgroup 155-2 after a resource barrier 135 has been reached using the portions of the compute unit resources 118 now fully allocated to the second workgroup 155-2.

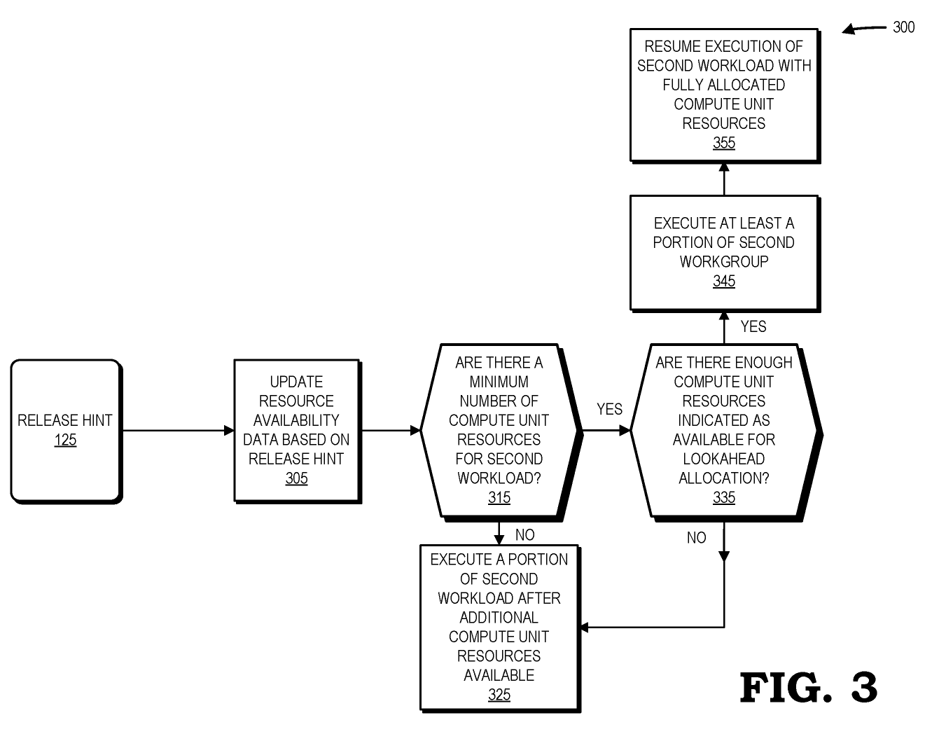

Referring now to FIG. 3, an example operation 300 for scheduling workgroups based on resource release hints is presented, in accordance with embodiments. In embodiments, example operation 300 is implemented at least in part by AU 110, lookahead scheduling circuitry 116, or both. Example operation 300 includes, at block 305, lookahead scheduling circuitry 116 receiving a resource release hint 125 concurrently with one or more compute units 228 executing a prologue or compute stage of a first workgroup 155-1. In response to receiving the resource release hint 125, lookahead scheduling circuitry 116 updates the resource availability data 205 of the portions of compute unit resources 118 identified in the resource release hint 125. For example, lookahead scheduling circuitry 116 updates the resource availability data 205 to indicate that portions of compute unit resources 118 are available for lookahead allocation 235 based on the received resource release hint 125 indicating that the end of the use of those portions of compute unit resources 118 by the first workgroup 155-1 is imminent (e.g., use of those portions of compute unit resources 118 by the first workgroup 155-1 will end in a predetermined amount of time). At block 315, lookahead scheduling circuitry 116 determines the resource requirements of a second workgroup 155-2. For example, lookahead scheduling circuitry 116 determines the number or amount of certain compute unit resources 118 required or requested by the second workgroup 155-2 for execution based on the attributes 185, resource barriers 135, dependency barriers 145, or any combination thereof of the second workgroup 155-2. Further, still referring to block 315, lookahead scheduling circuitry 116 is configured to determine whether a minimum number of resources are available to execute at least a portion of a prologue stage, compute stage, or both of the second workgroup 155-2. For example, lookahead scheduling circuitry 116 determines whether a number of compute units 228 and portions of compute unit resources 118 necessary for performing at least a portion of the prologue stage of the second workgroup 155-2 are indicated as available for allocation 215. As another example, lookahead scheduling circuitry 116 determines whether a number of compute units 228 and portions of compute unit resources 118 necessary for performing at least a portion of compute stage of the second workgroup 155-2 before a resource barrier 135 is met are indicated as available for allocation 215

In response to a number of compute units 228 and portions of compute unit resources 118 necessary for performing at least a portion of the prologue stage, compute stage, or both of the second workgroup 155-2 not being indicated as available for allocation 215, lookahead scheduling circuitry 116, at block 325, determines that a number of resources needed to execute at least a portion of the prologue stage of the second workgroup 155-2 are not available. Because this number of resources is not available, lookahead scheduling circuitry 116 suspends execution of the second workgroup 155-2 and waits until additional portions of compute unit resources 118 are indicated as available for allocation 215, one or more waves 115 or workgroups 155 have terminated, or both. Additionally, referring again to block 315, in response to a number of compute units 228 and portions of compute unit resources 118 necessary for performing at least a portion of the prologue stage, compute stage, or both of the second workgroup 155-2 being indicated as available for allocation 215, lookahead scheduling circuitry 116, at block 335, determines that a number of compute unit resources 118 needed to execute at least a portion of the prologue stage, compute stage, or both of the second workgroup 155-2 are available. Lookahead scheduling circuitry 116 then determines whether there are enough portions of compute unit resources 118 indicated as available for lookahead allocation 235 for executing at least a portion of the prologue stage, a compute stage, or both of the second workgroup 155-2. For example, lookahead scheduling circuitry 116 determines whether there are enough portions of compute unit resources 118 indicated as available for lookahead allocation 235 for executing an end portion of the prologue stage of the second workgroup 155-2 during which lookahead scheduling circuitry 116 stores data in one or more portions of compute unit resources 118. As another example, lookahead scheduling circuitry 116 determines whether there are enough portions of compute unit resources 118 indicated as available for lookahead allocation 235 for executing a compute stage of the second workgroup 155-2after a resource barrier 135 or dependency barrier 145 are met.

In response to determining that there are not enough portions of compute unit resources 118 indicated as available for lookahead allocation 235 for executing at least a portion of the prologue stage, a compute stage, or both of the second workgroup 155-2, at block 325, lookahead scheduling circuitry 116 suspends execution of the second workgroup 155-2 and waits until additional portions of compute unit resources 118 are indicated as available for allocation 215, one or more waves 115 or workgroups 155 have terminated, or both. Further, referring again to block 335, in response to determining that there are enough portions of compute unit resources 118 indicated as available for lookahead allocation 235 for executing at least a portion of the prologue stage, a compute stage, or both of the second workgroup 155-2, at block 345, lookahead scheduling circuitry 116 provisionally allocates one or more portions of compute unit resources 118 indicated as available for lookahead allocation 235 to the second workgroup 155-2 and begins execution of the second workgroup 155-2. As an example, lookahead scheduling circuitry 116 first updates the resource availability data 205 of the portions of compute unit resources 118 provisionally allocated to the second workgroup 155-2 to indicate that these portions of compute unit resources 118 are provisionally allocated 245. Lookahead scheduling circuitry 116 then begins executing at least a portion of a prologue stage, compute stage, or both of the second workgroup 155-2 during which lookahead scheduling circuitry 116 determines memory addresses for the second workgroup 155-2 based on the portions of compute unit resources 118 provisionally allocated to the second workgroup 155-2, copies instructions of the second workgroup 155-2 based on the determined memory addresses, stores data used in the execution of the portion second workgroup 155-2 in one or more fully allocated portions of compute unit resources 118, sets one or more initial register values, or any combination thereof. As an example, lookahead scheduling circuitry 116 executes at least a portion of a compute stage until a resource barrier 135 is met. At block 355, concurrently with lookahead scheduling circuitry 116 executing at least a portion of the prologue stage, compute stage, or both of the second workgroup 155-2, the first workgroup 155-1 ends use of and releases the portions of compute unit resources 118 provisionally allocated to the second workgroup 155-2. Due to these portions of compute unit resources 118 being released, lookahead scheduling circuitry 116 fully allocates these portions of compute unit resources 118 to the second workgroup 155-2 such that the portions of compute unit resources 118 are available for use by the second workgroup 155-2. Additionally, lookahead scheduling circuitry 116 updates the resource availability data 205 associated with these fully allocated portions of compute unit resources 118 to indicate that these portions of compute unit resources 118 are allocated 225.

Still referring to block 355, lookahead scheduling circuitry 116 then continues to execute the second workgroup 155-2 using the portions of compute unit resources 118 now fully allocated to the second workgroup 155-2. As an example, lookahead scheduling circuitry 116 performs a portion of the prologue stage of the second workgroup 155-2 during which the lookahead scheduling circuitry 116 stores data used in the execution of a compute stage of the second workgroup 155-2 in one or more portions of compute unit resources 118 fully allocated to the second workgroup 155-2. As another example, lookahead scheduling circuitry 116 executes at least a portion of a compute stage of the second workgroup 155-2 after a met resource barrier 135 using the one or more portions of compute unit resources 118 now fully allocated to the second workgroup 155-2.

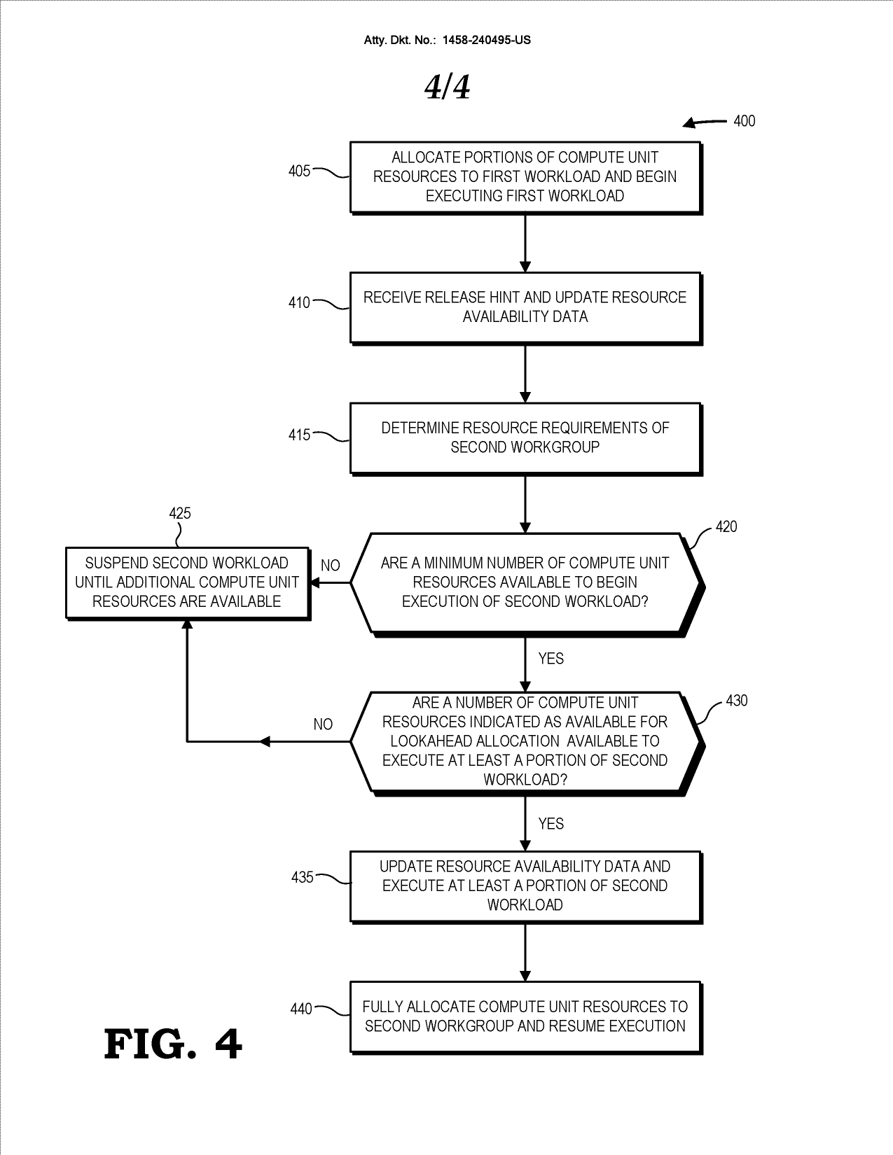

Referring now to FIG. 4, a method 400 for lookahead workgroup scheduling is presented, in accordance with embodiments. In embodiments, at least a portion of method 400 is implemented at least in part by AU 110, lookahead scheduling circuitry 116, one or more compute units 228, or any combination thereof. Method 400 includes, at block 405, lookahead scheduling circuitry 116 allocating one or more portions of compute unit resources 118 to a first workgroup 155-1 of a kernel 105. For example, lookahead scheduling circuitry 116 first determines the number or amount of compute unit resources 118 required or requested by the first workgroup 155-1 based on one or more attributes 185, resource barriers 135, dependency barriers 145, or any combination thereof of the first workgroup 155-1 indicated in the kernel 105. Lookahead scheduling circuitry 116 then allocates one or more compute units 228 and one or more portions of compute unit resources 118 of AU 110 to the first workgroup 155-1 based on the determined number or amount of compute unit resources 118 requires or requested by the first workgroup 155-1. As an example, lookahead scheduling circuitry 116 allocated portions of compute unit resources 118 equal to the determined number or amount of compute unit resources 118 required or requested by the first workgroup 155-1 to the first workgroup 155-1. After allocating these portions of compute unit resources 118 to the first workgroup 155-1, lookahead scheduling circuitry 116 updates the resource availability data 205 associated with these allocated portions of compute unit resources 118 to indicate that the portions of compute unit resources 118 are allocated 225. Further, after allocating these portions of compute unit resources 118 to the first workgroup 155-1, lookahead scheduling circuitry 116 begins executing a prologue stage, compute stage, or both of the first workgroup 155-1.

Concurrently with execution at least a portion of the prologue stage or compute stage of the first workgroup 155-1, at block 410, lookahead scheduling circuitry 116 receives a resource release hint 125 indicating that the first workgroup 155-1 is imminently going to end the use of one or more portions of compute unit resources 118 allocated to the first workgroup 155-1. As an example, the resource release hint 125 identifies a certain number or amount of certain compute unit resources 118 allocated to the first workgroup 155-1 that the first workgroup 155-1 will stop using in a predetermined amount of time (e.g., a predetermined number of cycles). Lookahead scheduling circuitry 116 then updates the resource availability data 205 based on the resource release hint 125. For example, lookahead scheduling circuitry 116 updates the resource availability data 205 associated with the portions of compute unit resources 118 identified in the resource release hint 125 to indicate that the identified portions of compute unit resources 118 are available for lookahead allocation 235. After updating the resource availability data 205, at block 415, lookahead scheduling circuitry 116 is configured to determine the resource requirements of a second workgroup 155-2. That is to say, lookahead scheduling circuitry 116 determines the number or amount of certain compute unit resources 118 required or requested by the second workgroup 155-2 for execution of at least a portion of a prologue stage, compute stage, or both. As an example, lookahead scheduling circuitry 116 determines the number or amount of certain compute unit resources 118 required or requested by the second workgroup 155-2 for execution based on one or more attributes 185, resource barriers 135, dependency barriers 145, or any combination thereof of the second workgroup 155-2 indicated in the kernel 105. As another example, based on an indicated resource barrier 135, the second workgroup 155-2 requests a number or amount of compute unit resources 118 as indicated by the resource barrier 135.

At block 420, lookahead scheduling circuitry 116 determines whether a minimum number of compute units 228 and portions of compute unit resources 118 are available to execute at least a portion of a prologue stage, compute stage, or both of the second workgroup 155-2. For example, lookahead scheduling circuitry 116 determines whether a minimum number of compute units 228 and portions of compute unit resources 118 are available (e.g., indicated as available for allocation 215) to determine memory addresses for the second workgroup 155-2, copy one or more instructions for the second workgroup 155-2, store data used in the execution of the second workgroup 155-2 in one or more allocated portions of compute unit resources 118, set one or more initial register values, or any combination thereof. In response to determining that a minimum number of compute units 228 or portions of compute unit resources 118 are not available to execute at least a portion of a prologue stage, compute stage, or both of the second workgroup 155-2, at block 425, lookahead scheduling circuitry 116 suspends execution of the second workgroup 155-2 until the first workgroup 155-1 terminates, one or more additional portions of compute unit resources 118 become available, or both. Referring again to block 420, in response to determining that a minimum number of compute units 228 and portions of compute unit resources 118 are available to execute at least a portion of a prologue stage, compute stage, or both of the second workgroup 155-2, lookahead scheduling circuitry 116 moves to block 430. At block 430, lookahead scheduling circuitry 116 determines whether there is a number of portions of compute unit resources 118 indicated as available for lookahead allocation 235 necessary for executing at least a portion of the prologue stage, compute stage, or both second workgroup 155-2. As an example, lookahead scheduling circuitry 116 determines whether there is a number of portions of compute unit resources 118 indicated as available for lookahead allocation 235 necessary for executing at least a portion of the second workgroup 155-2 based on the resource requirements determined for the second workgroup 155-2. In response to determining that there are not a number of portions of compute unit resources 118 indicated as available for lookahead allocation 235 necessary for executing at least a portion of the second workgroup 155-2, lookahead scheduling circuitry 116, at block 425, suspends execution of the second workgroup 155-2 until the first workgroup 155-1 terminates, one or more additional portions of compute unit resources 118 become available, or both.

Referring again to block 430, in response to determining that there are not a number of portions of compute unit resources 118 indicated as available for lookahead allocation 235 necessary for executing at least a portion of the second workgroup 155-2, lookahead scheduling circuitry 116, at block 435, preliminary allocates one or more portions of compute unit resources 118 indicated as available for lookahead allocation 235 to the second workgroup 155-2. Further, lookahead scheduling circuitry 116 updates the resource availability data 205 associated with the portions of compute unit resources 118 provisionally allocated to the second workgroup 155-2 to indicate that the portions of compute unit resources 118 are provisionally allocated 245. After provisionally allocating the one or more portions of compute unit resources 118 to the second workgroup 155-2, lookahead scheduling circuitry 116 beings executing at least a portion of the second workgroup 155-2 based on the portions of compute unit resources 118 provisionally allocated to the second workgroup 155-2. For example, lookahead scheduling circuitry 116 executes at least a portion of a prologue stage or compute stage of the second workgroup 155-2 during which lookahead scheduling circuitry 116 determines memory addresses for the second workgroup 155-2 based on the portions of compute unit resources 118 provisionally allocated to the second workgroup 155-2, copies one or more instructions of the second workgroup 155-2 based on the determined memory addresses, stores data used in the execution of the second workgroup 155-2 in one or more allocated portions of compute unit resources 118, sets one or more initial registers values, or any combination thereof. At block 440, concurrently with lookahead scheduling circuitry 116 executing at least a portion of the second workgroup 155-2 based on the portions of compute unit resources 118 being provisionally allocated to the second workgroup 155-2, the first workgroup 155-1 ends use of and releases the portions of compute unit resources 118 provisionally allocated to the second workgroup 155-2. Lookahead scheduling circuitry 116 then fully allocates the portions of compute unit resources 118 provisionally allocated to the second workgroup 155-2 such that the portions of compute unit resources 118 are available for use by the second workgroup 155-2. Further, lookahead scheduling circuitry 116 updates the resource availability data 205 of these fully allocated portions of compute unit resources 118 to indicate allocated 225. Additionally, at block 440, lookahead scheduling circuitry 116 resumes execution of the second workgroup 155-2 using the fully allocated portions of compute unit resources 118. As an example, lookahead scheduling circuitry 116 performs at least a portions of a prologue stage, compute stage, or both of the second workgroup 155-2 using the fully allocated portions of compute unit resources 118.

In some embodiments, the apparatus and techniques described above are implemented in a system including one or more integrated circuit (IC) devices (also referred to as integrated circuit packages or microchips), such as the AU 110 described above with reference to FIGS. 1-4. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An accelerator unit (AU), comprising:
one or more compute units;
a set of resources; and
scheduling circuitry configured to:
execute at least a portion of a first workgroup using one or more portions of resources allocated to the first workgroup from the set of resources; and
concurrently with the first workgroup using the one or more portions of resources of the set of resources:
provisionally allocate the one or more portions of resources to a second workgroup; and
execute at least a portion of the second workgroup based on the one or more portions of resources being provisionally allocated to the second workgroup.

2. The AU of claim 1, wherein the scheduling circuitry is configured to:
concurrently with executing the at least a portion of the first workgroup, receive a resource release hint indicating that use of the one or more portions of resources is to end.

3. The AU of claim 2, wherein the scheduling circuitry is configured to:
update a resource availability data to indicate that the one or more portions of resources are available for lookahead allocation based on the resource release hint.

4. The AU of claim 3, wherein the scheduling circuitry is configured to:
provisionally allocate the one or more portions of resources to the second workgroup based on the resource availability data indicating that the one or more portions of resources are available for lookahead allocation.

5. The AU of claim 1, wherein the scheduling circuity is configured to:
concurrently with the first workgroup using the one or more portions of the resources, determine one or more memory addresses for the second workgroup based on the one or more portions of resources.

6. The AU of claim 1, wherein the scheduling circuitry is configured to:
concurrently with executing the at least a portion of the second workgroup and in response to the first workgroup ending use of the one or more portions of resources, allocate the one or more portions of resources to the second workgroup so that the one or more portions of resources are available for use by the second workgroup.

7. The AU of claim 6, wherein the scheduling circuitry is configured to:
execute at least a portion of a compute stage of the second workgroup using the one or more portions of resources based on a resource barrier, wherein the resource barrier indicates a point in the second workgroup.

8. The AU of claim 7, wherein the AU is configured to execute a compute kernel indicating the first workgroup, the second workgroup, and the resource barrier.

9. A method, comprising:
executing, by an accelerator unit (AU), at least a portion of a first workgroup using one or more portions of resources allocated to the first workgroup from a set of resources of the AU; and
concurrently with the first workgroup using the one or more portions of the resources:
provisionally allocating the one or more portions of resources to a second workgroup; and
executing, by the AU, at least a portion of the second workgroup based on the one or more portions of resources being provisionally allocated.

10. The method of claim 9, further comprising:
concurrently with executing the at least a portion of the first workgroup, receiving a resource release hint indicating that use of the one or more portions of resources is to end.

11. The method of claim 10, further comprising:
updating a resource availability data to indicate that the one or more portions of resources are available for lookahead allocation based on the resource release hint.

12. The method of claim 11, further comprising:
provisionally allocating the one or more portions of resources to the second workgroup based on the resource availability data indicating that the one or more portions of resources are available for lookahead allocation.

13. The method of claim 9, further comprising:
concurrently with the first workgroup using the one or more portions of the resources, determining one or more memory addresses for the second workgroup based on the one or more portions of resources.

14. The method of claim 9, further comprising:
concurrently with executing the at least a portion of the second workgroup and in response to the first workgroup ending use of the one or more portions of resources, allocating the one or more portions of resources to the second workgroup so that the one or more portions of resources are available for use by the second workgroup.

15. The method of claim 14, further comprising:
executing, by the AU, at least a portion of a compute stage of the second workgroup using the one or more portions of resources based on a dependency barrier, wherein the dependency barrier indicates a point in the second workgroup.

16. A processing system, comprising:
a memory; and
an accelerator unit (AU) configured to execute a compute kernel indicating a first workgroup and a second workgroup, the AU including:
a set of resources;
and scheduling circuitry configured to:
allocate one or more portions of resources from the set of resources to the first workgroup;
concurrently with the first workgroup using the one or more portions of the resources, provisionally allocate the one or more portions of resources to a second workgroup; and
execute at least a portion of the second workgroup based on the one or more portions of resources being provisionally allocated to the second workgroup.

17. The processing system of claim 16, wherein the scheduling circuitry is configured to:
receive a resource release hint indicating that use of the one or more portions of resources by the first workgroup is to end.

18. The processing system of claim 17, wherein the scheduling circuitry is configured to:
update a resource availability data to indicate that the one or more portions of resources are available for lookahead allocation based on the resource release hint; and
provisionally allocate the one or more portions of resources to the second workgroup based on the resource availability data indicating that the one or more portions of resources are available for lookahead allocation.

19. The processing system of claim 16, wherein the scheduling circuity is configured to:
in response to data resulting from the first workgroup being stored in the memory, fully allocate the one or more portions of resources to the second workgroup so that the one or more portions of resources are available for use by the second workgroup.

20. The processing system of claim 19, wherein the scheduling circuitry is configured to:
execute at least a portion of a compute stage of the second workgroup using the one or more portions of resources.
